(19) United States
(12) Patent Application Publication
(10) Pub. No.: US 2018/0052757 A1
(43) Pub. Date: Feb. 22, 2018

(54) MEDIA CONTENT MONITORING METHOD, SYSTEM AND DEVICE

(71) Applicant: Oxbow Social Media Monitoring, Inc., Westlake, OH (US)

(72) Inventors: Chip Krueger, Bay Village, OH (US); Daniel R. Krueger, Bay Village, OH (US)

(21) Appl. No.: 15/169,637

(22) Filed: May 31, 2016

Related U.S. Application Data
(60) Provisional application No. 62/168,845, filed on May 31, 2015.

(51) Int. Cl. G06F 11/34; G06F 17/30; G06Q 50/00

(52) U.S. Cl. CPC G06F 11/3438; G06F 17/30035; G06Q 50/01; G06F 17/3005; G06F 17/30867

(57) ABSTRACT

A system, method and device to monitor publication of a media content to online sources includes generation of the media content by a first computing device after which a second computing device is notified by a server connected to both of the computing devices. The second computing device is further configured to make a decision on publication of the media content based on its appropriateness. The content is published on the online source only if the second computing device approves the publication.

### CROSS-REFERENCE TO RELATED APPLICATIONS

This application claims the benefit under 35 U.S.C. §119(e) of U.S. Provisional Patent Application Ser. No. 62/168,845, filed May 31, 2015 and entitled “MEDIA CONTENT MONITORING METHOD, SYSTEM AND DEVICE”, the disclosure of which is herein incorporated by reference.

### FIELD OF THE INVENTION

The present invention relates generally to publication of data, and more particularly to a portable device, system and method to control ensure publication of the data to social networking websites.

### BACKGROUND OF THE INVENTION

Online sources are basis of immense information and knowledge source in today's world. It is being used by people of all ages these days to gain and share information. Major online sources of information exchange are online blogs, internet websites like Wikipedia, and social networking websites.

Social networking websites have a great impact on our lives. People of all ages share information on these social networking websites. However, any one can post any kind of content to these websites. Although, the websites have various content display and upload policies, but, they seldom work and there are various ways in which these policies can be violated.

Therefore, there is a need to monitor the media content before the content is uploaded to such social networking websites.

### SUMMARY OF THE INVENTION

A method, system and device are disclosed to monitor a media content to be published in any of available online sources.

In an embodiment of the invention, a method to monitor media content i.e. to be published is disclosed. The method includes the media content being generated by a first user using a first computing device. When the media content is generated it is sent to a second computing device belonging to a second user in form of a notification. The notification includes querying the second user through a user interface about publication of the media content on online sources based on appropriateness of the media content. The second user can then input his/her response on the appropriateness of the media content through the user interface.

In another embodiment of the invention, a system to monitor a media content to be published is disclosed. The system includes a server which is connected to a first computing device and a second computing device through wireless or wired connections. The first device includes a media content generation module, through which the media content is generated. Further, the system includes a decision module which receives a notification whenever the first computing device generates a media content. The second computing device is capable of making a publication of the media content based on the appropriateness of the media content on online sources.

In yet another embodiment of the invention, a computing device that is adapted to monitor a media content generated by an owner is disclosed. The computing device includes a display to display the media content generated by the owner of the media content. The computing device further contains a memory inn which an application is installed that initiates the monitoring of the media content. The computing device furthermore contains a processor which is in connection with the display and the memory wherein, the processor is configured to display a notification when the media content gets generated. The notification is so configured so as to receive the input to make a publication decision of the media content. Also, the processor is configured to transmit an acknowledgement containing the publication decision of the media content to the owner of the media content.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a line diagram illustrating a system to monitor a media content generated according to an embodiment of the invention;

FIG. 2 is a block diagram illustrating inner components of a first computing device according to an embodiment of the invention;

FIG. 3 is a block diagram illustrating inner components of a second computing device according to an embodiment of the invention;

FIG. 4a-4b illustrates exemplary views of the second computing device to add devices according to an exemplary embodiment of the invention;

FIG. 5 is a flow chart illustrating a method for monitoring a media content according to an embodiment of the invention;

FIG. 6A-6D illustrates exemplary views of the second computing device to monitor generated media content according to an exemplary embodiment of the present invention;

FIG. 7 illustrates exemplary view of the first computing device after the media content has been approved, denied or pending for a decision according to an exemplary embodiment of the invention.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments

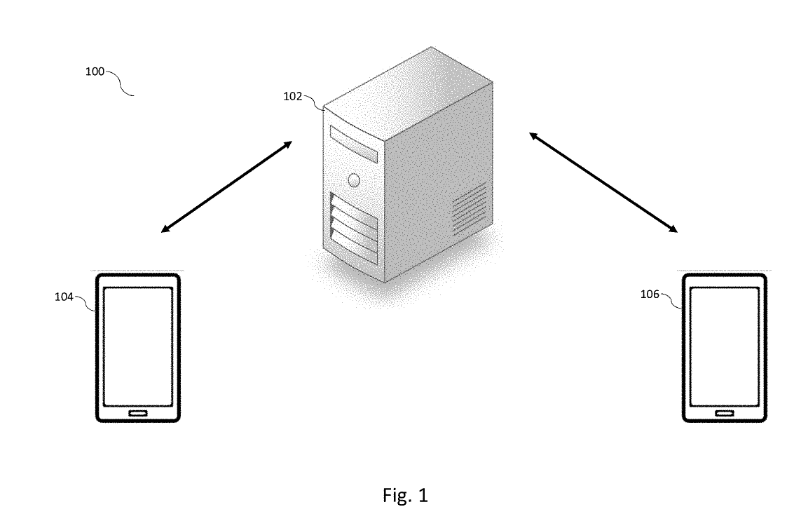

In describing the exemplary embodiments of the present invention, as illustrated in FIGS. 1-6 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1, which illustrates a system 100 to monitor a media content generated according to an embodiment of the invention. The system 100 includes a server 102 that is communication with a first computing device 104 and a second computing device 106. The server 102 is configured to store a list of a plurality of connected computing devices (not shown). In an embodiment of the invention the first computing device 104 and the second computing device 106 are configured to be connected to the server 102 through any one of a wireless or wired communication channel. In an embodiment of the invention the wireless communication channel can be however, not limited to a Wi Fi connection, Bluetooth, IR channel, cellular channel, 3G, 4G, etc. Furthermore, in a yet another embodiment of the invention, the wired connection can be any one of an Ethernet, LAN, etc.

The first computing device 104 and the second computing device 106 can be however, not limited to a mobile phone, a wireless device, a laptop, a personal computer, a tablet, a personal digital assistant, a portable music device, an mp3 player, a camera, or a communicator device.

In an embodiment of the invention the first computing device i.e. a mobile phone could generate a media content. The media content could be however, not limited to an image file, a video file, a document, a comic strip, an audio file, or an animated content.

The second computing device 106 receives a notification on a display of the second computing device 106 whenever the first computing device 104 generates a media content. The second device 106, can then make a decision as to publish the media content or not on online sources. In an embodiment of the invention the online sources could be however, not limiting to the scope of the invention, a social networking website, a blog, etc.

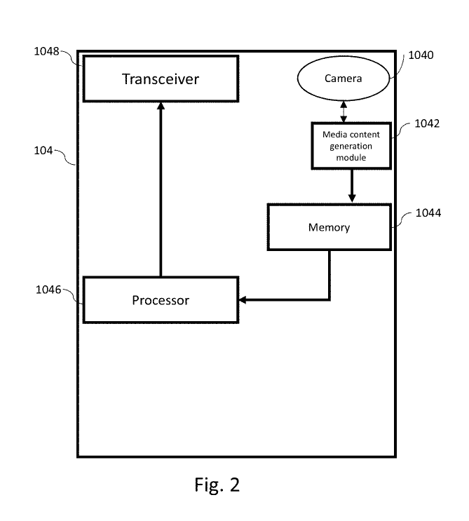

Details of the above mentioned system 100, will be disclosed with reference to FIGS. 2 & 3 to explain the further details of the system 100.

FIG. 2 illustrates inner components of the first computing device 104. In an embodiment of the invention, the first computing device is configured to generate an image file as the media content. To generate the image file, the first computing device 104 is equipped with an inbuilt camera 1040. The inbuilt camera is connected to a media content generation module 1042. The media content generation module 1042 can be however, not limited to a software application. The user of the first computing device 104 initiates the media content generation by clicking on the user interface projected by the media content generation module 1042. The user is directly redirected to the camera 1040 when the user of the first computing device 104 initiates the media content generation module 1042. The user of the first computing device 104 can then take a picture as desired using the camera 1040 which the user wishes to publish to a social networking website. The first computing device 104 further contains a memory 1044 to store the picture taken by the user. The first computing device 104 also includes a processor 1046 that extracts the picture i.e. to be published on the social networking website and transmits the picture using a transceiver 1048 to the second computing device 106 through the server 102, to decide as to whether publish the picture or not to the social networking website.

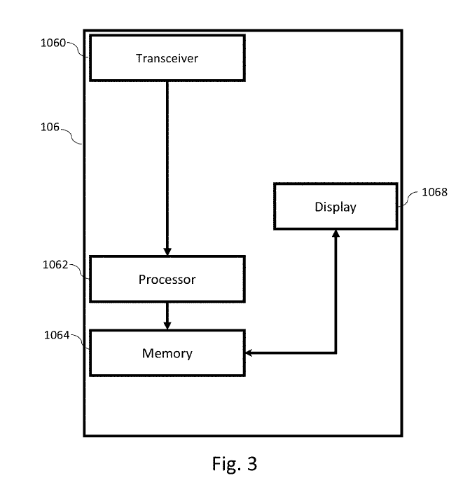

Moving to FIG. 3 illustrates inner components of the second computing device 106. The second computing device also includes a transceiver 1060 to receive a notification including the picture taken by the first computing device 104 using its camera 1040. The transceiver 1060 after receiving the notification including the picture on which a publication decision needs to be taken is passed on to a processor 1062 which further passes on the picture to a memory 1064. The picture is then further displayed as a notification on a display 1068 of the second computing device 106. The displayed notification can include an acceptance or denial of publication of the picture to online sources.

According to an embodiment of the invention the first computing device 104 could be a governed device or a supervised device whereas the second computing device 106 is a governing or supervising device. The first computing device could belong to a child, a minor, a student, a junior, an employee, a trainee, etc. Also, the second computing device 106 could belong to a parent, a guardian, a teacher, a senior, an employer, a trainer, etc. Therefore, the system 100 provides the parent, the guardian, the senior, the employer, the trainer, etc. and option to control the publication of media content that is generated by the child, the minor, the student, the junior, the employee, the trainee, etc.

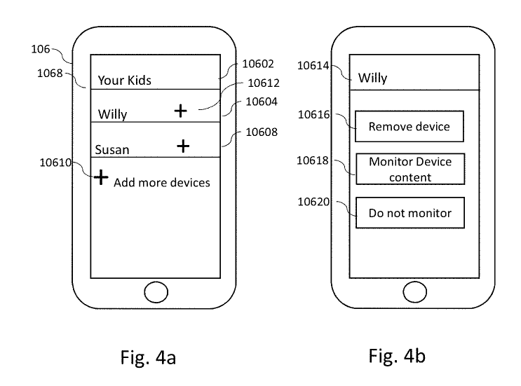

Referring to FIG. 4a illustrating the claimed invention in an exemplary embodiment of the invention. The second computing device 106 which has the software application installed may be initiated by a user to display on its display 1068 a list of subordinate devices which are being supervised by the second computing device 106. The display 1068, displays a “Your Kids” section in one part of the display 1068. The list below shown could be already added devices like as illustrated in FIG. 4a for e.g. 10604 and 10608. The names of the device owners could include a soft button like 10612 a plus sign. Another soft button 10610 could be provided to further enable user of the second computing device 106 to add more devices that he/she may like to add to the list. In an embodiment of the invention, when the user of the second computing device clicks on this soft button 10610, he may be taken to a contacts section (not shown) where he may choose any contact who the user may want to add. Further, when the user clicks on to the soft button 10612 the user is navigated to another screen on the display 1068 as depicted in FIG. 4b. Here he may choose from various options that may be provided like remove device option 10616 which removes the subordinate current device from the list, monitor device content option 10618, that helps the second computing device 106 to monitor any content that is being generated from the subordinate device belonging to a user (like child), or do not monitor option 10620 that may provide the user of the second computing device with an option to opt out from monitoring content originating from the subordinate device. Hence, in this manner the user of the second computing device has various options related to listed subordinate devices.

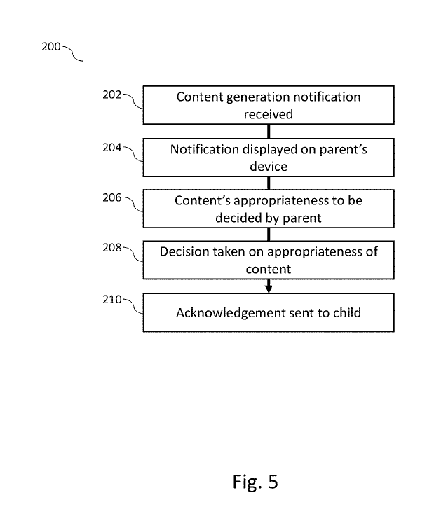

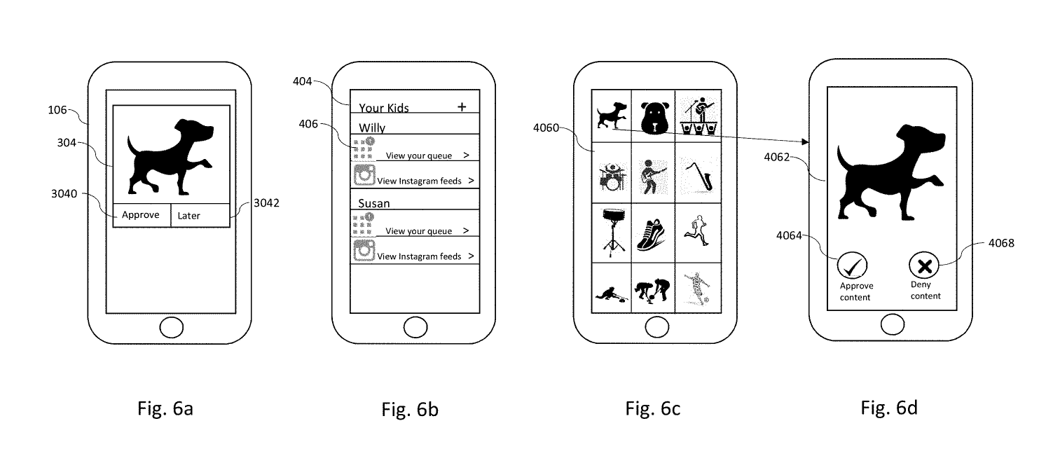

Referring to FIG. 5 which depicts a flow chart illustrating a method 200 to monitor a media content by the second computing device 106. Reference will be made to FIG. 6a-6d while explaining the method FIG. f. In an embodiment of the invention, the method 200 could be performed using a software application installed wherein a first module of the software application is installed within the first computing device 104 and a second module could be installed within the second computing device 106. The software application could be written in anyone language like JAVA (trademark of Oracle Inc.), ANDROID (trademark of Google Inc.), and iOS (trademark of Apple Inc.)

The method 200 initiates at step 202 when the second computing device 106 receives a notification. The notification is displayed on the display 1068 on a user interface 304 at step 204 including the media content to be published on online sources. In an embodiment of the invention, the notification 304 may include soft buttons 3040 to approve the media content for publication, or 3042 to view the media content later.

As mentioned above, in an embodiment of the invention, the first computing device 104 could be a supervised device and the second computing device 106 could be a supervising device. The second software module of the software application installed on the second computing device 106 can be initiated wherein multiple supervised devices could be linked to a single supervising device. Such devices and media content generated by them can be listed in the software module installed within the second computing device 106. The software module when initiated by the user displays a list of devices 404 supervised by the second computing device. As shown in FIG. 6b a list of devices is listed on user interface 404. The listing could include options like view queue 406 of media content waiting to be approved for publication on online sources. The options could further include tabs to view published media contents as well.

When the user of the second computing device 106, clicks on to tab 406, the application navigates the user to a next screen 406 as shown in FIG. 6c that displays all media content (image files in this case) waiting to be approved by the user.

Referring to FIG. 5, at step 206, the user decides on appropriateness of the media content from all the media content being displayed on screen 4060. Clicking on any media enlarges that media file to fit to device's screen as shown in 4062 in FIG. 6d.

At step 208, the appropriateness of the media content as displayed 4062 with soft buttons to either approve content 4064 or deny content 4068. The user of the second computing device 106 can then click on any of the button according to the content of the media content.

Further, at step 210 an acknowledgement is sent to the owner of the media content so as to display a status of the approval or denial of publication of the media content.

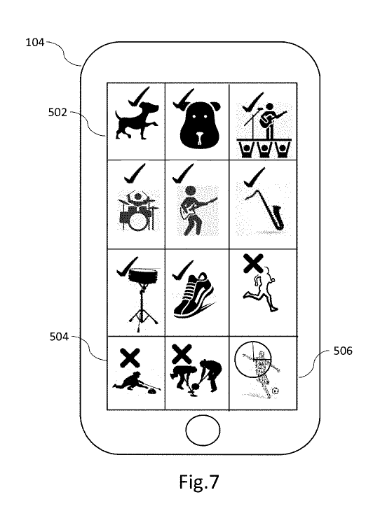

Referring to FIG. 7 that illustrates an exemplary view of the first computing device 104 according to an embodiment of the invention after receiving an acknowledgement received indicating status of the media content publication request. The first computing device 104 may display through a user interface of the software application by a “tick” mark on content 502 that has been approved by the second computing device 106. Furthermore, content which has not been approved are displayed with a cross sign 504. Also, the content, which has not yet been viewed by the second computing device may be displayed with a “time pending” mark 506. In an embodiment of the invention, clicking on the tick marked content 502 will publish the content to the social networking websites.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended paragraphs. Accordingly, the present invention is not limited to the specific embodiments illustrated herein, but is limited only by the preceding paragraphs.

What is claimed:

1. A method for selective actuation of a pre-emptive approval or denial of a media content to be published, the method comprising; (1) linking a plurality of subordinate computing devices to a supervising computing device wherein, the subordinate computing devices are adapted to generate media content; (2) selecting at least one subordinate device by the supervising computing device; and (3) notifying the supervising computing device whenever the selected at least one subordinate device generates a media content for publication for the pre-emptive approval or denial of the media content.

2. The method of claim 1 wherein, the method further comprises publishing automatically a media content generated from remaining subordinate computing devices.

3. The method of claim 1 wherein, the method further comprises publishing the media content only if the supervising computing device approves it.

4. The method of claim 1 wherein, the media content is one of an image file, a video file, a document, a comic strip, an audio file, or an animated content.

5. The method of claim 1 wherein, the subordinate computing devices and the supervising computing device is one of a mobile phone, a wireless device, a laptop, a personal computer, a tablet, a personal digital assistant, a portable music device, an mp3 player, a camera, or a communicator device.

6. A system for selective actuation of a pre-emptive approval or denial of a media content to be published, the system comprising; (1) a plurality of subordinate computing devices; (2) a supervising computing device; (3) a server; (4) a network wherein, the plurality of subordinate devices and the supervising computing device are linked to the server through the network; and (5) a user interface inherent to the supervising computing device to select at least one subordinate computing device wherein; (a) the user interface is further configured to; (b) notify the supervising computing device of a media content generated for publishing by the at least one subordinate computing device; and (c) make decision on approval or denial of publishing the media content.

7. The system of claim 6 wherein, the system publishes the media content on approval from the supervising computing device.

8. The system of claim 6 wherein, the system publishes media content generated by remaining subordinate devices automatically.

9. The system of claim 6 wherein, the media content is one of an image file, a video file, a document, a comic strip, an audio file, or an animated content.

10. The system of claim 6 wherein, the subordinate computing devices and the supervising computing device is one of a mobile phone, a wireless device, a laptop, a personal computer, a tablet, a personal digital assistant, a portable music device, an mp3 player, a camera, or a communicator device.

11. The system of claim 6 wherein, the network is one of a wireless network or a wired network.

12. A computing device adapted to selectively actuate pre-emptive approval or denial of a media content to be published, the computing device comprising; (1) a memory; (2) a processor; and (3) a display in communication with the memory and the processor wherein, the display is configured to; (a) display a list of subordinate computing devices being supervised by the computing device; (b) select at least one subordinate device; (c) notify when the at least one subordinate device generates a media content publication; and (d) approve or deny publication of the media content.

13. The computing device of claim 12 wherein, the computing device and the subordinate computing device is one of a mobile phone, a wireless device, a laptop, a personal computer, a tablet, a personal digital assistant, a portable music device, an mp3 player, a camera, or a communicator device.

14. The computing device of claim 12 wherein, the media content is one of an image file, a video file, a document, a comic strip, an audio file, or an animated content.
